(19) United States
(12) Patent Application Publication
(10) Pub. No.: US 2009/0174528 A1
(43) Pub. Date: Jul. 9, 2009

(54) Apparatus for communicating with RFID tag using optical information

(75) Inventors: Katsumi Toda, Toyota-shi (JP); Tsuyoshi Ohashi, Hashima-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/378,902

(22) Filed: Feb. 20, 2009

Related U.S. Application Data
(63) Continuation-in-part of application No. PCT/JP07/65829, filed on Aug. 13, 2007.

(30) Foreign Application Priority Data
Aug. 21, 2006 (JP) 2006-224375

(51) Int. Cl. H04Q 5/22

(52) U.S. Cl. 340/10.1

(57) ABSTRACT

An apparatus for communicating with a RFID tag includes on an upper part of a housing with a display part provided, an antenna configured to perform radio communication with a RFID circuit element provided at an article to be detected; and a barcode sensor configured to optically get tag grasping information from a barcode provided with the tag grasping information for grasping the RFID circuit element to be communicated with the antenna.

### CROSS-REFERENCE TO RELATED APPLICATIONS

This is a CIP application PCT/JP2007/065829, filed Aug. 13, 2007, which was not published under PCT article 21(2) in English.

### BACKGROUND OF THE INVENTION

1. Field of the Invention

The present invention relates to an apparatus for communicating with a RFID tag using optical information configured to transmit/receive information through radio communication to a RFID circuit element capable of information transmission/reception with the outside.

2. Description of the Related Art

A RFID (Radio Frequency Identification) system configured to perform reading/writing of information contactlessly between a small-sized RFID tag and a reader (reading device)/writer (writing device) has been known. A RFID circuit element provided at the RFID tag includes an IC circuit part storing predetermined RFID tag information and an antenna connected to the IC circuit part for information transmission/reception so that an access to the RFID tag information in the IC circuit part (information reading/writing) can be made from the side of the reader/writer, even if the RFID tag is stained or arranged in a hidden position, and has been already put into practice in various fields such as merchandise control, inspection process and the like.

As an example that the RFID tag is applied to a logistics system, the one as described in JP, A, 2001-19167 is known, for example. This prior art is applied to cargo loading and unloading management performed by a driver when a cargo is delivered by a truck. That is, the RFID circuit element (RFID IC tag) is provided at each cargo loaded on the truck and a reader (antenna) is provided around a cargo loading/unloading gate of the truck so that cargo information such as destination, contents and the like of the cargo is got from the RFID circuit element of each cargo when the cargo passes through the gate at loading/unloading and compared with cargo information got from a server of a logistics information center in advance for check. With this arrangement, automatic check on whether the cargo is loaded or unloaded as scheduled is enabled.

However, if the RFID tags are attached to a plurality of articles distributed in logistics and the plurality of articles are detected as above, for example, since the reader usually has a communication range with some degrees of expansion, all the RFID tags in the communication range reply response signals. At this time, though the article as a target can be visually known, which one is the response signal of the RFID tag attached to the target is not known. That is, if there is a plurality of articles to be detected in the communication range, there is a fear that the communication target can not be grasped and the article can not be detected.

### SUMMARY OF THE INVENTION

The present invention provides an apparatus for communicating with a RFID tag using optical information that can surely detect articles even if there is a plurality of articles to be detected in the communication range.

### BRIEF DESCRIPTION OF THE DRAWING

FIG. 1 is a front view illustrating an apparatus for communicating with a RFID tag according to a first embodiment of the present invention.

FIG. 2 is a block diagram illustrating an example of functional configuration of a RFID circuit element provided at a RFID label provided at an article to be detected by a reader in FIG. 1.

FIG. 3 is a functional block diagram illustrating configuration of a control system of the reader in FIG. 1.

FIG. 4 is a functional block diagram illustrating a detailed function of a control circuit provided at the control system in FIG. 3.

FIG. 5 is an explanatory diagram illustrating detection processing of a plurality of articles in an article case.

FIG. 6 is a flowchart illustrating a control procedure in article detection processing.

FIG. 7 is an explanatory diagram illustrating an example of association between barcode information and a tag ID in a variation in which at least a part of the tag ID of the RFID circuit element is recorded in the barcode.

FIGS. 8A and 8B are a flowchart illustrating a control procedure in the article detection processing and a diagram illustrating a tag ID list to be acquired, respectively.

FIG. 9 is an explanatory diagram illustrating association between barcode information and tag memory information in a second embodiment of the present invention.

FIGS. 10A and 10B are a flowchart illustrating a control procedure in the article detection processing and a diagram illustrating the produced tag ID list, respectively.

FIG. 11 is a table illustrating an example of a correspondence table showing correlation between the barcode information and the tag ID.

FIG. 12 is a flowchart illustrating a control procedure in the article detection processing.

FIGS. 13A and 13B are a perspective view schematically illustrating an apparatus for producing a RFID label with barcode according to a third embodiment of the present invention and a plan view illustrating the produced RFID label, respectively.

FIG. 14 is a conceptual diagram illustrating detailed configuration of the apparatus for producing a RFID label shown in FIG. 13A.

FIG. 15 is a flowchart illustrating a control procedure executed by the control circuit.

### DETAILED DESCRIPTION OF THE PREFERRED EMBODIMENTS

Embodiments of the present invention will be described below referring to the attached drawings.

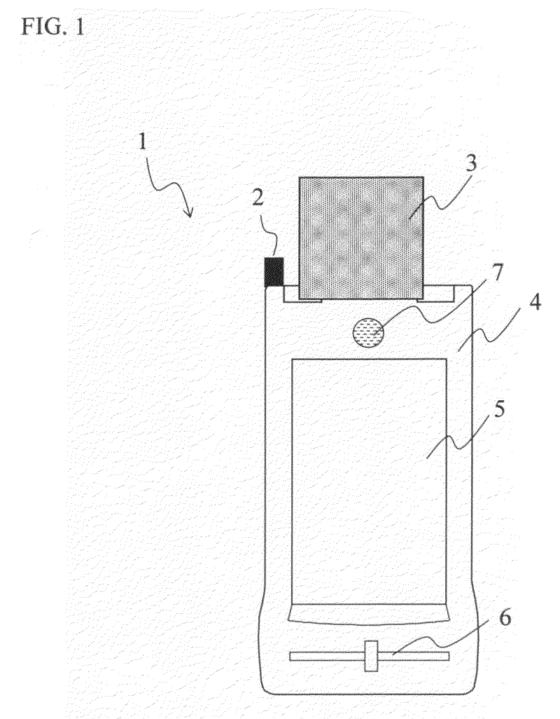

A first embodiment of the present invention will be described referring to FIGS. 1 to 8. The present embodiment is an embodiment when the present invention is used for detection processing of plural articles in an article case.

FIG. 1 is a front view illustrating an apparatus for communicating with a RFID tag using optical information according to the present embodiment.

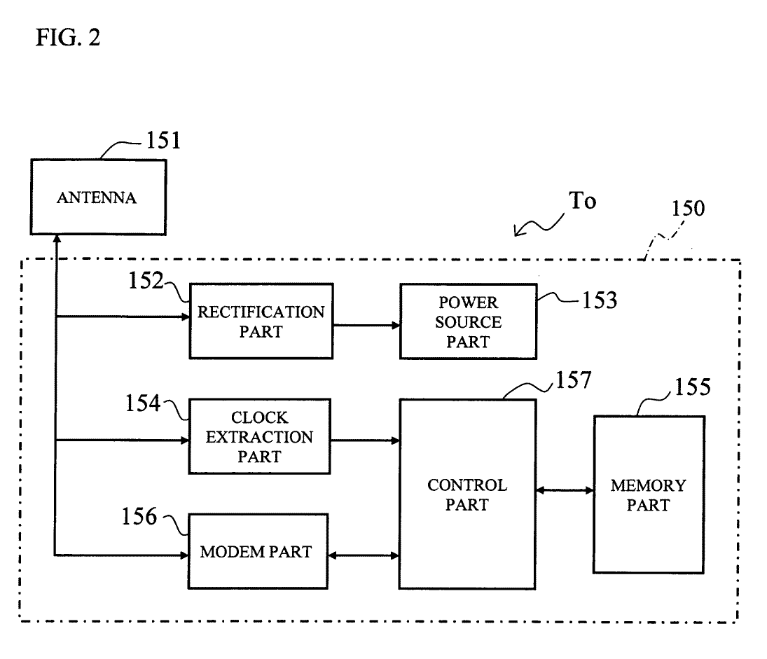

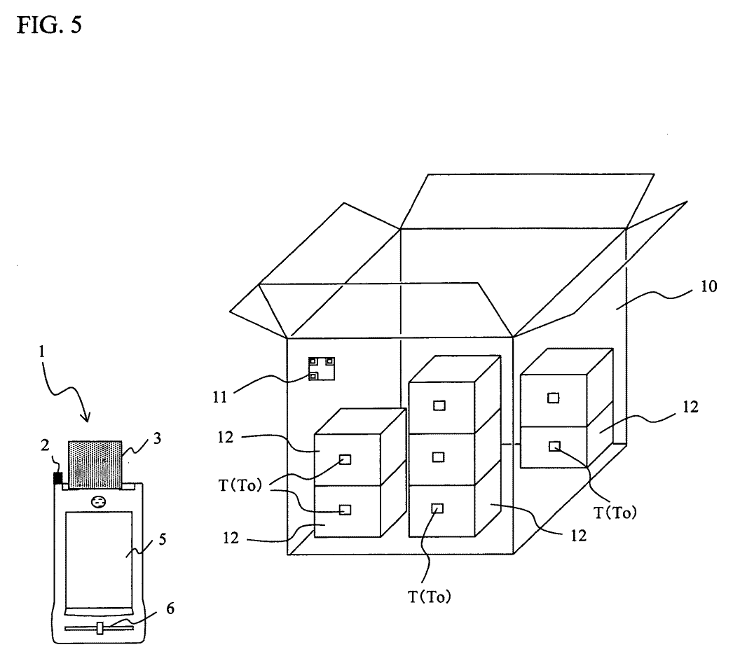

In FIG. 1, this apparatus 1 for communicating with a RFID tag (reader) responds to both a RFID circuit element To (See FIG. 2 and the like, which will be described later) provided at a RFID label T (See FIG. 5 and the like, which will be described later) and a barcode 11 (optical identifier. See FIG. 5 and the like, which will be described later) and is capable of reading them (dual type).

That is, the apparatus 1 for communicating with a RFID tag is provided with an antenna (apparatus antenna) 2 as a first communication device at an upper part of a housing 4 provided with a display part 5 (display device), configured to perform radio communication with the RFID circuit element To provided at an article to be detected, and a barcode sensor (information acquisition device, related information processing device) 3 configured to optically get tag grasping information from a barcode (optical identifier) 11 provided with the tag grasping information for grasping the RFID circuit element To to be communicated with by the antenna 2.

The display part 5 is provided so as to occupy the majority of a surface side (front side in FIG. 1) of the housing 4 in this example. At the upper side of the display part 5, a voice notifying device 7 (buzzer, alarm, chime speaker and the like, for example), and at the lower side of the display part 5, an operation part 6 (mechanical in this example) constituting a part of an operating device are provided, respectively.

The display part 5 is constituted as a known touch panel in this example so that the majority of functions as the operating device can be executed by various buttons displayed on the touch panel. By the buttons and the like of the touch panel and the operation part 6, various operation inputs relating to display, search and the like can be made. This enables not only displaying various communication states and the like but also promoting space saving and facilitation of manual operations since the touch panel performs both the display function and the operation function.

The operation part 6 is a slider type in this example, but it may be any other appropriate key, button, switch, pad and the like. Moreover, it may be a so-called see-saw button or a thumb operated button and the like that can be operated with the device being held.

The device antenna 2 is constituted as a single directional or non-directional antenna, for example.

FIG. 2 is a block diagram illustrating an example of functional constitution of the RFID circuit element To provided at the RFID label T provided at an article to be detected of the reader 1.

In FIG. 2, the RFID circuit element To has an antenna 151 (tag antenna) configured to transmit/receive a signal contactlessly using a radio frequency such as a UHF band and the like with the antenna (apparatus antenna) 2 of the reader 1 and an IC circuit part 150 connected to this antenna 151.

The IC circuit part 150 includes: a rectification part 152 that rectifies a carrier wave received by the antenna 151; a power source part 153 that accumulates energy of the carrier wave rectified by the rectification part 152 so as to make it a driving power supply of the IC circuit part 150; a clock extraction part 154 that extracts a clock signal from the carrier wave received by the antenna 151 so as to supply it to a control part 157 (which will be described later); a memory part 155 that functions as an information storage part capable of storing a predetermined information signal; a modem part 156 connected to the antenna 151; and the control part 157 that controls operation of the RFID circuit element To through the rectification part 152, the clock extraction part 154, the modem part 156 and the like.

The modem part 156 demodulates a communication signal from the antenna 2 of the reader 1 received by the antenna 151, modulates the carrier wave received at the antenna 151 based on a response signal from the control part 157, and re-transmits it as a reflected wave from the antenna 151.

The control part 157 interprets a received signal demodulated by the modem part 156, generates a reply signal based on the information signal stored in the memory part 155, and executes basic control such as control of reply by the modem part 156.

The clock extraction part 154 extracts a clock component from a received signal and extracts a clock to the control part 157 and supplies the clock corresponding to a speed of the clock component of the received signal to the control part 157.

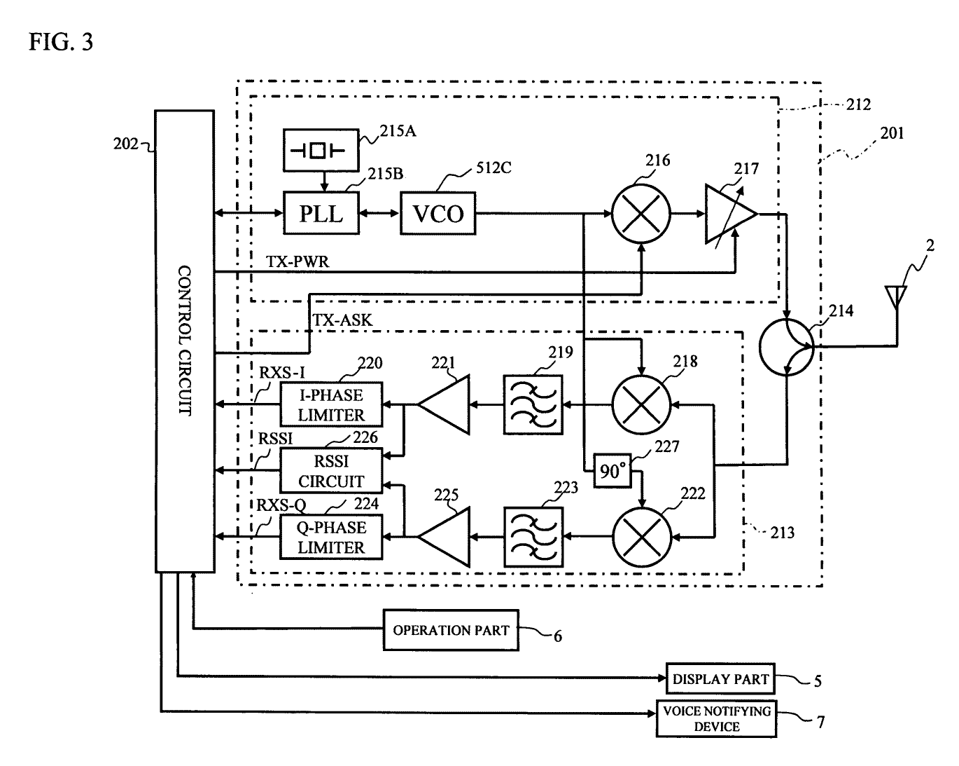

FIG. 3 is a functional block diagram illustrating configuration of a control system of the reader 1.

In FIG. 3, the control system of the reader 1 includes a radio frequency circuit 201 configured to make an access (for reading or writing) to information (RFID tag information including tag ID) of the IC circuit part 150 of the RFID circuit element To through the antenna 2, and a control circuit 202 including a function to process the signal read out of the IC circuit part 150 of the RFID circuit element To so as to read out information and to generate access information to access the IC circuit part 150 of the RFID circuit element To, and configured to control an operation of the entire reader 1.

The radio frequency circuit 201 includes a transmitting portion 212 configured to transmit a signal to the RFID circuit element To through the antenna 2, a receiving portion 213 to which a reflected wave from the RFID circuit element To received by the antenna 2 is input, and a transmit-receive splitter 214.

The transmitting portion 212 includes a crystal oscillator 215A configured to generate a carrier wave for accessing (for reading or writing) the RFID tag information in the IC circuit part 150 of the RFID circuit element To, a PLL (Phase Locked Loop) 215B and a VCO (Voltage Controlled Oscillator) 215C that generate a signal with a predetermined frequency by control of a control circuit 30, a transmission multiplying circuit 216 (however, it may be replaced by an amplitude factor variable amplifier or the like in the case of “TX_ASK signal”) that modulates (in this example, amplitude modulation according to the “TX_ASK” signal supplied from the control circuit 202) the carrier wave generated as described above according to a signal supplied from the control circuit 202, and a variable transmission amplifier 217 that amplifies the modulated waves modulated by the transmission multiplying circuit 216 (amplification with amplification factor determined according to a “TX_PWR” signal supplied from the control circuit 202 in this example). The carrier wave generated as above uses a frequency of the UHF band, microwave band or short wave band and the like and the output from the transmission amplifier 217 is transmitted to the transmission antenna 2 through the transmit-receive splitter 214 and is supplied to the IC circuit part 150 of the RFID circuit element To. The RFID tag information is not limited to the modulated signal as above but may be a mere carrier wave.

The receiving portion 213 includes a first receiving signal multiplying circuit 218 that multiplies the reflected wave received from the RFID circuit element To through the antenna 2 by the carrier wave generated as described above and demodulating it, a first bandpass filter 219 that extracts only the signals within the necessary band from the output of the first receiving signal multiplying circuit 218, a first receiving signal amplifier 221 that amplifies the output from the first bandpass filter 219, a first limiter 220 that further amplifies the output of the first receiving signal amplifier 221 and converts it to a digital signal, a second receiving signal multiplying circuit 222 that multiplies the reflected wave received from the RFID circuit element To through the antenna 2 by the carrier wave that is delayed by a phase shifter 227 by 90° after having been generated as described above, a second bandpass filter 223 that extracts only the signals within the necessary band from the output of the second receiving signal multiplying circuit 222, a second receiving signal amplifier 225 that amplifies the output of the second bandpass filter 223, and a second limiter 224 that further amplifies the output of the second receiving signal amplifier 225 and converts it to a digital signal. A signal “RXS-I” output from the first limiter 220 and a signal “RXS-Q” output from the second limiter 224 are input to the control circuit 202 for processing.

Also, the outputs from the first receiving signal amplifier 221 and the second receiving signal amplifier 225 are also input to an RSSI (Received Signal Strength Indicator) circuit 226 as an intensity detecting device. A signal “RSSI” indicating the intensity of these signals is input to the control circuit 202. As mentioned above, the reader 1 of this embodiment performs demodulation of the reflected wave from the RFID circuit element To by I-Q quadrature demodulation.

The control circuit 202 outputs an amplification control signal and a modulation control signal to the radio frequency circuit transmitting portion 212 and executes predetermined calculation processing for processing a signal read out of the RFID circuit element To after a received signal from the radio frequency circuit receiving portion 213 is input. The control circuit 202 also inputs an operation signal from the operating device such as the operation part 6 and the like and outputs a display control signal to the display part 5, a notification signal to the voice notifying device 7 and the like.

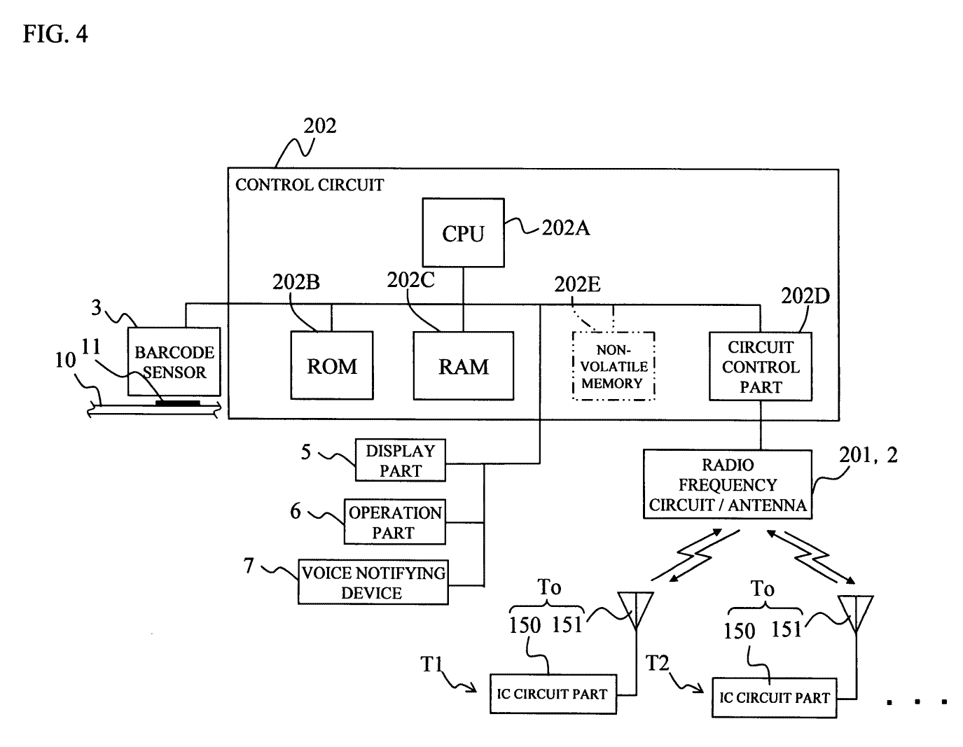

FIG. 4 is a functional block diagram illustrating a detailed function of the control circuit 202.

In FIG. 4, the control circuit 202 is a so-called microcomputer and includes a CPU 202A, which is a central processing unit, ROM 202B storing various programs, RAM 202C, which is a temporary storage memory, a circuit control part 202D that transmits/receives a signal with the antenna 2 (radio frequency circuit 201) and the barcode sensor 3 and the like and executes signal processing according to a program stored in the ROM 202B in advance using the temporary storage function provided by the RAM 202C. Furthermore, the control circuit 202 may be provided with an appropriate non-volatile memory 202E.

The above reader 1 optically reads out information (barcode information) stored in the barcode 11 by scanning the barcode sensor 3 along the barcode 11 using the barcode sensor 3 by various operation buttons displayed on the operation part 6 and the display part 5 and reads out tag ID (tag identification information) stored in the IC circuit part 150 provided at the RFID circuit element To by radio communication with the RFID circuit element To of the RFID label T (T1, T2, . . . ) through the antenna 2.

FIG. 5 is an explanatory diagram illustrating a situation in which detection processing is performed for plural articles in an article case using the reader 1 with the above configuration. For ease of understanding, the inside of the article case is also drawn with a solid line.

In FIG. 5, a plurality (seven pieces here) of articles 12 are stored in an article case 10 such as a packing case and the like, the RFID label T provided with the RFID circuit element To is attached to one side face of each article 12, and the barcode 11 is attached to one side face of the article case 10. A RFID tag not in a label state but in a card state or sheet state, for example, may be arranged, packed and the like. The article 12 to be detected is a document, equipment, material, facility, machinery and any other portable articles, for example.

The barcode 11 is a QR code, which is a two-dimensional barcode, in this example, but it may be a one-dimensional barcode. This barcode 11 is comprehensively associated with the plurality of articles 12 by being provided at the article case 10, and the number of the articles 12 (plural tag related information, tag grasping information) relating to the RFID circuit element To provided at each of the plurality of articles 12 is recorded in the barcode 11.

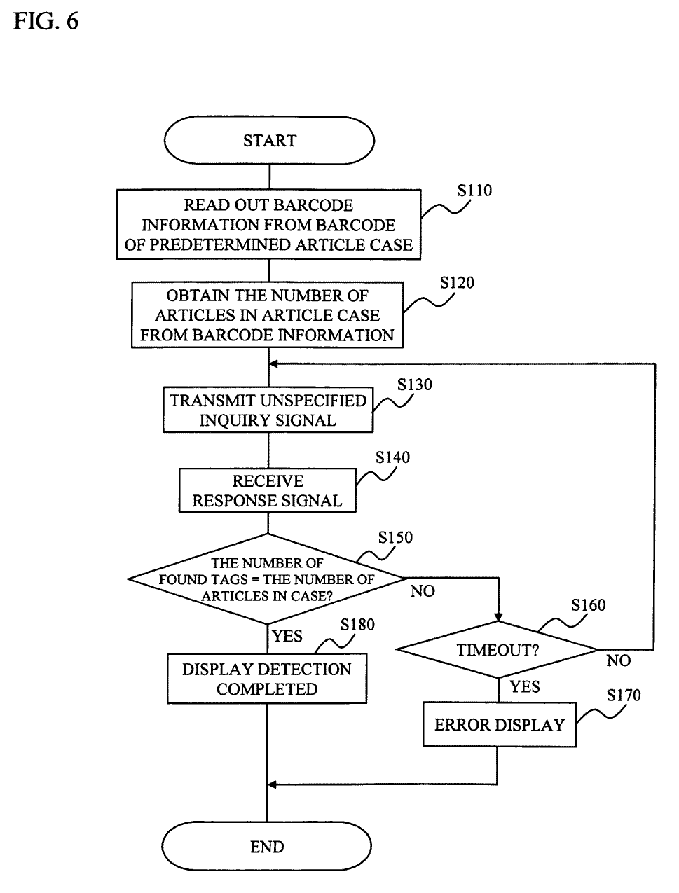

FIG. 6 is a flowchart illustrating a control procedure of the article detection processing executed by the CPU 202A of the control circuit 202.

In FIG. 6, first at Step S110, based on a detection result of the barcode sensor 3, barcode information is got from the barcode 11 provided at the predetermined article case 10.

Subsequently, at Step S120, based on the barcode information read out at Step S110, number information (the number of articles) of the articles 12 in the article case 10 is got.

Then, the routine goes to Step S130, where an unspecified inquiry command (“scroll All ID” command and the like, for example) for reading out the information stored in the RFID circuit element To of the RFID label T is output to the circuit control part 202D. Based on this command, an unspecified inquiry signal (“scroll All ID” signal and the like, for example) as access information is generated at the circuit control part 202D and transmitted to the RFID circuit element To through the radio frequency circuit 201 and the antenna 2 and a reply is prompted.

Subsequently, at Step S140, in response to the unspecified inquiry signal, a response signal (reply signal) transmitted from the RFID circuit element To of each article 12 to be accessed is received through the antenna 2 and taken in through the radio frequency circuit 201 and the circuit control part 202D. The number of response signals that can be received at this time can be made the number of the RFID labels T that could be found. If collision of the response signals is caused at transmission of the unspecified inquiry signal and the number of response signals can not be clearly specified, a search signal (such as a “Ping” signal and the like based on a “Ping” command) is transmitted so as to prompt response from the RFID circuit elements To in the communication range and a group of responses are classified by hierarchy and stored so that the number of response signals (=in other words, the number of RFID labels T found) can be specified in the end.

Subsequently, the routine goes to Step S150, where the number of found tags found by receiving of the response signal at Step S140 is checked with the number of articles in the article case got through the barcode 11 at Step S120 so as to determine if the number of found tags matches the got number of articles in the article case (first determining portion).

If the number of found tags does not match the got number of articles in the article case, the determination at Step S150 is not satisfied, and the routine goes to Step S160, where it is determined if a predetermined time has elapsed since transmission of the unspecified inquiry signal at Step S130. If the predetermined time has elapsed, it is considered that normal reading processing can not be performed, a display signal is output to the display part 5 of the reader 1 at Step S170 so as to make error display, and then, the routine is finished. If the predetermined time has not elapsed at Step S160, the routine returns to Step S130 and the similar procedure is repeated.

On the other hand, if the number of found tags matches the number of articles in the article case at Step S150, the determination is satisfied, a display signal is output to the display part 5 at Step S180 so as to make detection completion display and this flow is finished.

According to this embodiment, as mentioned above, if the plurality of articles 12 is stored in the article case 10, the number information of the articles 12 in the article case 10 is got by reading out the information of the barcode 1 with the barcode sensor 3 of the reader 1. On the other hand, the number information of the RFID circuit elements To relating to the article 12 is got via radio communication through the antenna 2. Then, by comparing the number information of the articles 12 and the number of the RFID circuit elements To and checking the match, the article detection of the articles 12 in the article case 10 can be completed.

In the above embodiment, only the number information of the article 12 is recorded as the plural tag related information in the barcode 11 provided at the article case 10, but not limited to that, at least a part of identification information (tag ID) of the RFID circuit element To relating to each article 12 may be recorded. In this case, the barcode 11 is read out with the barcode sensor 3 of the reader 1 so as to get the identification information (or part of it) of the RFID circuit element To, the RFID circuit element To be communicated with the reader 1 is specified using the got identification information at Step S130 in the above-mentioned FIG. 16, and information is transmitted/received using the unspecified inquiry signal (“Scroll ID” signal, “Ping” signal and the like, for example) from the antenna 2 so as to find the RFID label T.

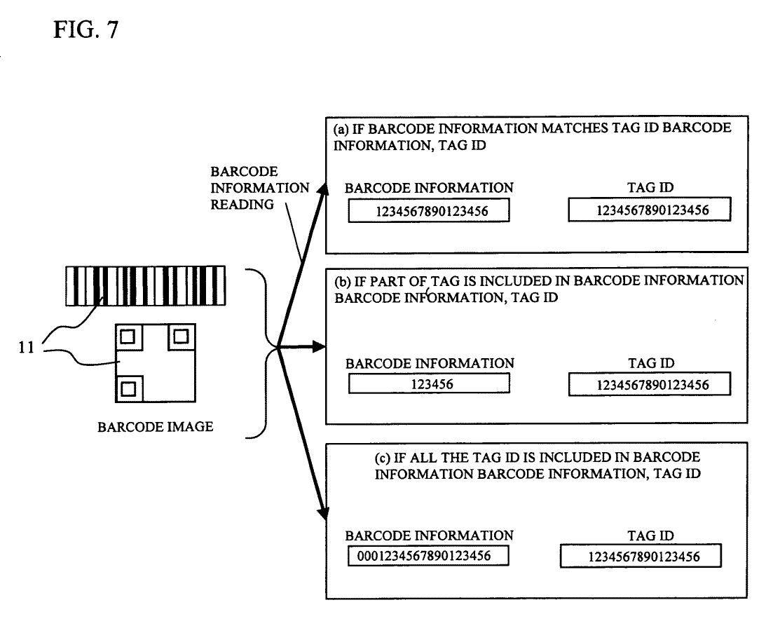

FIGS. 7A to 7C are conceptual explanatory diagrams illustrating an example of association between the barcode information and the tag ID in such variation.

FIG. 7A shows a case in which the barcode information matches the tag ID (the entire tag ID is recorded in the barcode 11), and in this case, the barcode information is specified as the tag ID as it is and an access can be made to the RFID circuit element To.

FIG. 7B shows a case in which the barcode information including a part of the tag ID is recorded in the barcode 11, and in this case, a common portion of the tag ID (if it is known in advance. Numerals “1234567890” in the example in the figure) is added to the barcode information, this is specified as the tag ID and an access can be made to the RFID circuit element To.

FIG. 7C shows a case in which the barcode information includes all the tag ID (the entire tag ID is recorded in the barcode 11), and in this case, only the tag ID portion excluding “000” (=if it is known in advance) from the barcode information is extracted, this is specified and an access can be made to the RFID circuit element To.

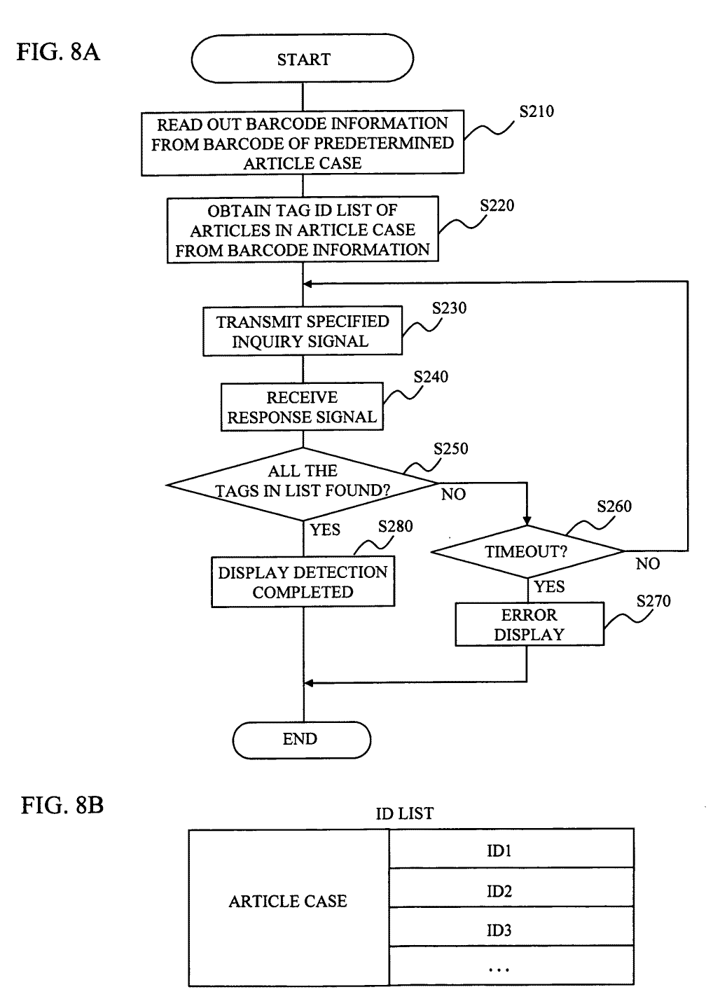

FIG. 8A is a flowchart illustrating a control procedure of the article detection processing executed by the CPU 202A of the control circuit 202 of this variation and substantially corresponds to FIG. 6 of the above embodiment.

In FIG. 8A, first, at Step S210, similarly to Step S110 in the above-mentioned FIG. 6, the barcode information is got from the barcode 11 provided at the predetermined article case 10 using the barcode sensor 3. This barcode information includes, as exemplified in FIGS. 7A to 7C, at least a part (plural tag related information) of the identification information (tag ID) of the RFID circuit element To relating to each article 12.

Subsequently, at Step S220, from the barcode information read out at Step S210, at least a part of the tag ID of the RFID circuit elements To of all the articles 12 in the article case 10 (hereinafter simply referred to as tag ID) is acquired in a list format (tag ID list) as shown in FIG. 8B, for example.

Then, at Step S320, based on the above acquired tag ID, the RFID circuit element To be communicated with is specified, and a specified inquiry command (such as “Scroll ID” command and “Ping” command) for reading out the information stored in the RFID circuit element To is output to the circuit control part 202D. Based on this command, a specified inquiry signal (“Scroll ID” signal or “Ping” signal) as access information is generated at the circuit control part 202D, transmitted to the RFID circuit element To be accessed provided with the tag ID through the radio frequency circuit 201 and the antenna 2, and a reply is prompted.

Subsequently, at Step S240, in response to the specified inquiry signal, a response signal (reply signal) transmitted from the RFID circuit element To of each article 12 to be accessed is received through the antenna 2 and taken in through the radio frequency circuit 201 and the circuit control part 202D. As a result, the RFID label T corresponding to each tag ID provided in the ID list can be sequentially found.

Then, at Step S250, it is determined whether or not all the RFID labels T corresponding to each tag ID provided in the ID list have been found by the receiving of the response signal. The determination is not satisfied till all the tags are found, and the routine goes to Step S260, where it is determined if a predetermined time has elapsed since transmission of the specified inquiry signal at Step S230. If the predetermined time has elapsed, it is considered that normal reading processing was not performed, and error display is made at the display part 5 of the reader 1 at Step S270 and then, this routine is finished. If the predetermined time has not elapsed yet at Step S260, the routine returns to Step S230 and the similar procedure is repeated.

On the other hand, at Step S250, if all the RFID labels T corresponding to each tag ID provided in the ID list are found, the determination is satisfied, a display signal is output to the display part 5 at Step S280 for detection completed display and this flow is finished.

In this variation, as mentioned above, if the plurality of articles 12 is stored in the article case 10, identification information (or a part thereof) of the RFID circuit element To is got from the barcode 11 of the article case 10 by the barcode sensor 3 of the reader 1, the RFID circuit element To be communicated with is specified using the identification information and information transmission/reception is performed, and the article detection can be completed by completion of the information transmission/reception on all the articles 12 in the case 10.

Also, particularly in this variation, since the barcode information itself constitutes at least a part of the tag ID of the RFID circuit element To, there is an effect that the article detection processing can be performed rapidly and efficiently as compared with the tag ID acquisition by separately accessing a server based on the barcode information.

As mentioned above, if the identification information (or a part thereof. The same applies to the following) of the RFID circuit element To is got (in a list format, for example) from the bar code 11, the identification information of all the RFID circuit elements To provided at the plurality of articles 12 do not necessarily have to be got. That is, if there is a certain regularity and the like in allocation of the identification information, it may be so configured that the identification information of the RFID circuit elements To provided at least at a part of the articles 12 in the plurality of articles 12 is got (in the list extracted format, for example) and by the got identification information, the identification information of the RFID circuit elements To provided at the remaining articles 12 is calculated (estimated, guessed) and the like.

If only the first and last numbers of a series of identification information (tag ID) of the RFID circuit elements To relating to all the articles 12 in the article case 10 and sequentially arranged are recorded, when tag IDs “1234”, “1334” are acquired from the barcodes 11, it may be so configured that the information transmission/reception is performed limited to the tag IDs in the range from the “1123” to “1334” and the RFID circuit element To is read out.

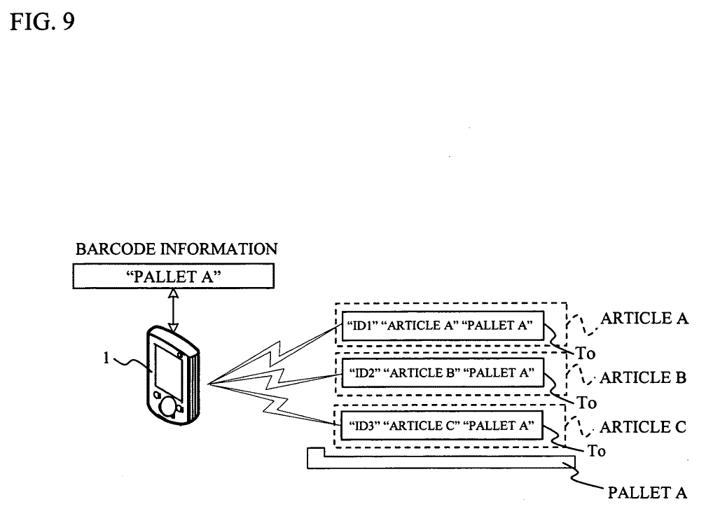

A second embodiment of the present invention will be described referring to FIGS. 9 to 12. This embodiment is an embodiment in which attribute information of the article 12 is used as tag grasping information. The same reference numerals are given to the portions equivalent to those in the first embodiment, and the description thereof will be omitted or simplified as appropriate.

FIG. 9 is an explanatory diagram conceptually illustrating association between the barcode information of the barcode 11 and the information stored in the RFID circuit element To in this embodiment.

In FIG. 9, the articles 12 are arranged in a pallet A by a predetermined quantity, for example. In the RFID circuit element To of the RFID label T provided at the article 12, the respective identification information (tag ID), attribute information (in this case, pallet information such as pallet name and the like where the article 12 is arranged) of the article 12 to be associated with each RFID circuit element To, and article information (article type, article name and the like) together with them in this case are recorded. That is, as shown in FIG. 9, the tag ID, attribute information, and article information such as “ID1”, “Pallet A”, and “Article A” are stored in the IC circuit part 150 of the RFID circuit element To provided at the article A, for example. Similarly, “ID2”, “Pallet A”, and “Article B” are stored in the IC circuit part 150 of the RFID circuit element To provided at the article B, and “ID3”, “Pallet A”, and “Article C” are stored in the IC circuit part 150 of the RFID circuit element To provided at the article C.

In this embodiment, as shown in FIG. 9, for example, the above attribute information “Pallet A” is recorded in the barcode 11. Therefore, by acquiring the “Pallet A” (pallet name) from the barcode 11 and by detecting the RFID circuit element To storing the attribute information of the “Pallet A” when information transmission/reception is performed with each RFID circuit element To through the antenna 2, the targeted RFID circuit element To is specified (separately from those mounted on the other pallets B, C, . . . in this example), and thereby by performing the information transmission/reception with the specified RFID circuit element To, the article detection of the specified article can be completed.

The barcode 11 may be in an appropriate installation mode, and it is needless to say that the barcode may be provided at the article 12 itself or the article case 10 or an article display shelf or moreover, it may be suitably put into practice by being printed on an article management ledger and the like.

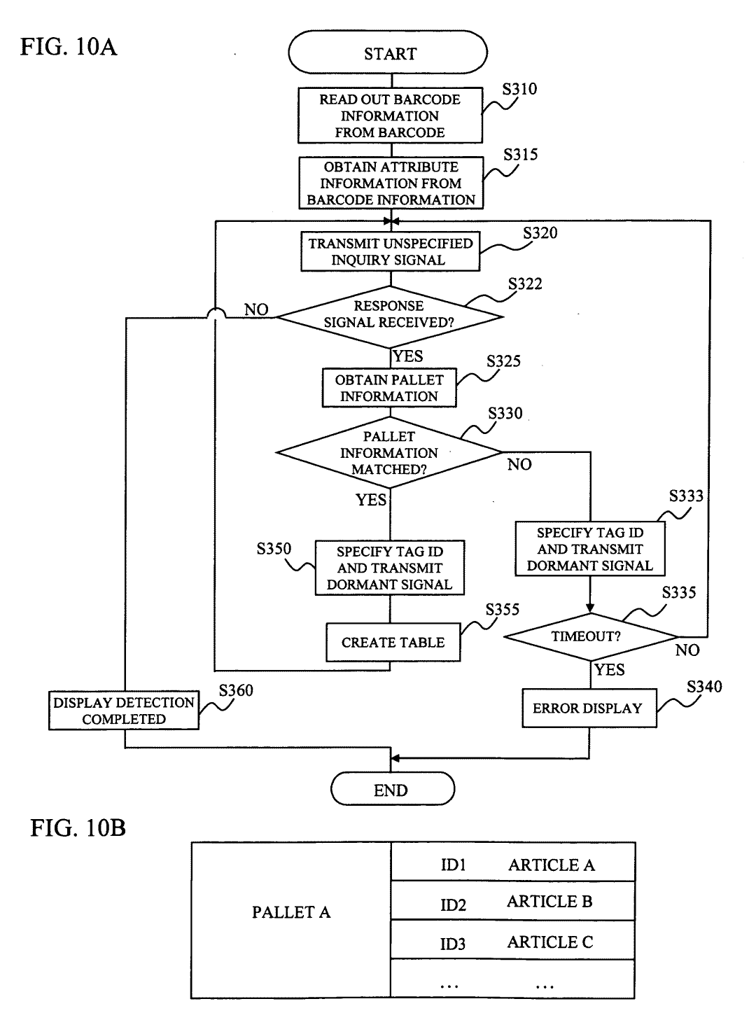

FIG. 10A is a flowchart illustrating a control procedure of the article detection processing executed by the CPU 202A of the control circuit 202 in this embodiment in order to execute the above.

In FIG. 10A, first at Step S310, based on the detection result of the barcode sensor 3, the barcode information is got from the above-mentioned article 12 itself, the article case 10 or the article shelf barcode 11 and the like.

Subsequently, at Step S315, based on the barcode information read out at Step S310, the attribute information (“Pallet A” in the example in FIG. 9) as the tag grasping information is got.

Then, the routine goes to Step S320, where an unspecified inquiry command (“Scroll All ID” command and the like, for example) for reading out the information stored in the RFID circuit element To of the RFID label T is output to the circuit control part 202D. Based on this command, the unspecified inquiry signal as the access information (“Scroll All ID” signal and the like, for example) is generated at the circuit control part 202D and transmitted to the RFID circuit element To through the radio frequency circuit 201 and the antenna 2, and a reply is prompted.

Subsequently, at Step S322, in response to the above unspecified inquiry signal, it is determined if a response signal (reply signal) transmitted from the RFID circuit element To of each article 12 to be accessed has been received through the antenna 2 and taken in through the radio frequency circuit 201 and the circuit control part 202D. If it has been received, the determination is satisfied, and the routine goes to Step S325.

Similarly to the above, if the response signal can not be clearly specified because of collision of the response signals at transmission of the above unspecified inquiry signal, it is only necessary that a search signal (such as “Ping” signal based on “Ping” command and the like) is transmitted so as to prompt a response from the RFID circuit elements To in the communication range, and the response signal is specified in the end by hierarchically sorting and storing the group of responses.

Subsequently, at Step S330, the attribute information (pallet name in this example) stored in each RFID circuit element To included in each response signal from each RFID circuit element To together with the tag ID is extracted and got at Step S325, and the got attribute information is checked with the attribute information got based on the barcode information at Step S315. Then, it is determined if the two pieces of the attribute information match each other (if the attribute information got from the RFID circuit element To is the “Pallet A” or not in the above example) (second determining portion).

If the pieces of attribute information do not match each other, the determination at Step S330 is not satisfied, and the routine goes to Step S333.

At Step S333, the tag ID specified at Step S325 is designated and a dormant command (“Sleep” command and the like) for making the RFID circuit element To dormant is output to the circuit control part 202D. Based on this command, a dormant signal as access information is generated at the circuit control part 202D and transmitted through the radio frequency circuit 201 and the antenna 2 to the RFID circuit element To be accessed provided with the tag ID and it is made dormant (the communication function is temporarily stopped).

Subsequently, the routine goes to Step S335, where it is determined if a predetermined time has elapsed since transmission of the unspecified inquiry signal at Step S320 or not. If the predetermined time has not elapsed, the processing of the transmission of the unspecified inquiry signal at Step S320 and after is repeated. If the RFID circuit element To with the non-matched attribute information is detected in the above, Step S320 to Step S333 are repeated so that the RFID circuit element To is made dormant one after another and the RFID circuit element To with the matched attribute information can be smoothly detected. If the predetermined time has elapsed at Step S335, it is considered that normal reading-out processing could not be performed, a display signal is output to the display part 5 at Step S340 for making an error display and then, this routine is finished.

On the other hand, at Step S330, if the attribute information is matched (in the above example, if the attribute information read out of the RFID circuit element To is the “Pallet A”), the determination is satisfied and the routine goes to Step S350.

At Step S350, the tag ID specified at Step S325 is designated (identification information specifying portion), and the dormant command (“Sleep” command and the like) for making the RFID circuit element To dormant is output to the circuit control part 202D. Based on this command, the dormant signal as access information is generated at the circuit control part 202D and transmitted through the radio frequency circuit 201 and the antenna 2 to the RFID circuit element To be accessed provided with the tag ID, and it is made dormant (the communication function is temporarily stopped).

Subsequently, at Step S355, correlation between the tag ID (identification information) acquired at Step S325 and the pallet name (attribute information) is created in a table format shown in FIG. 10B (correlation creating portion), for example, and stored in the RAM 202C, for example.

When Step S355 is finished, the routine returns to the above Step S320 and the unspecified inquiry signal is transmitted similarly, and the subsequent procedure is repeated. By repeating Step S320 to Step S355 as above and by writing the tag ID of the RFID circuit element To with matched attribute information in the table while making it dormant each time, when detection of all the RFID circuit elements To is completed, the response is not received any more and the determination at Step S322 is not satisfied. Then, the routine goes to Step S360 and a display signal is output to the display part 5 for detection completion display, and this flow is finished.

With this embodiment, too, the same effect as that in the first embodiment is acquired. That is, using the barcode information got using the barcode sensor 3, a list can be created using the attribute information included in the barcode information as a clue and the RFID circuit element To be communicated with (attached to the article A, the article B, the article C arranged in the pallet A in the above example) can be specified. As a result, even if a large number of articles to be detected including the article mounted on another pallet are present in the communication range of the reader 1, the article detection can be completed based on the above specification result.

In the above second embodiment, the attribute information (pallet information) is provided in the barcode 11, the information is got at Step S315, it is determined at Step S330 if it matches the pallet information got from the response signal of the RFID circuit element To at Step S235, and the RFID circuit element To is specified one after another based on the determination, but not limited to that. For example, if the article information (“Article A” and the like) is provided as the tag grasping information in the barcode 11, it may be so configured that the information is got at Step S315 and the article information (See “Article A” and the like in FIG. 9) included in the response signal of the RFID circuit element To is got at Step S235, it is determined if the article information matches each other or not at Step S330, and the RFID circuit element To is specified one after another based on the determination. In this case, at Step S355, a correspondence table (correlation table) representing the correlation between the barcode information corresponding one-to-one to each article and the tag ID may be created (correlation creating portion) and stored in the RAM 202C, for example.

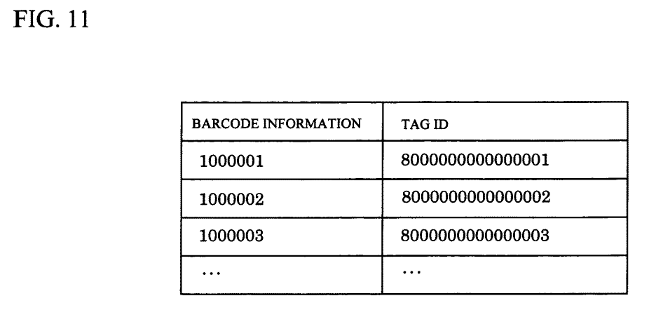

FIG. 11 is a table illustrating an example of the correlation between the barcode information and the tag ID created in this variation.

In FIG. 11, in this example, the barcode information is constituted by a 7-bit sequence of “1” and “0”, while the corresponding tag ID is constituted by a 16-bit sequence of “1” and “0”. As shown in the figure, the barcode information and the tag ID are associated with each other in a one-to-one manner in these sequences (association between adjacent columns in each row in the table).

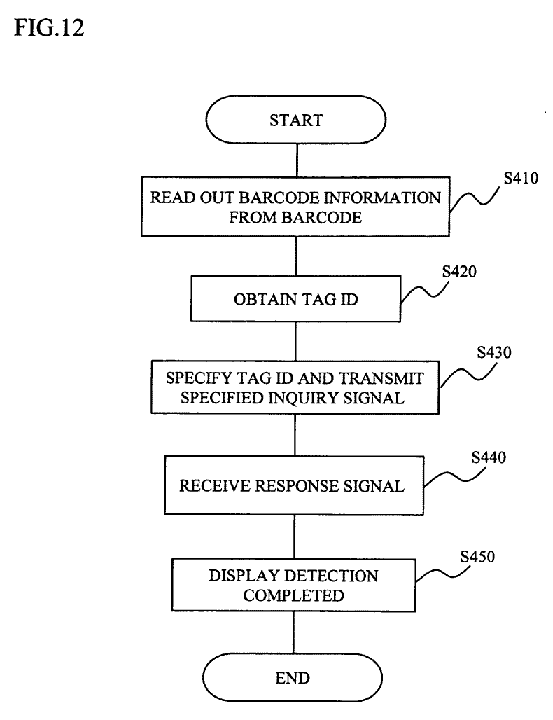

FIG. 12 is a flowchart illustrating a control procedure of the article detection processing after the table has been created as above.

That is, in FIG. 12, first, at Step S410, the barcode information is read out based on the detection result of the barcode sensor 3, and the identification information (tag ID) of the RFID circuit element To is specified at Step S420 using the above correlation table from the barcode information got at Step S410. Subsequently, at Step S430, the acquired tag ID is specified and the specified inquiry signal (“Scroll ID” signal) is transmitted to the RFID circuit element To and a response signal from the RFID circuit element To responding to the inquiry signal is received at Step S440. When the detection of the article is completed by receiving of the response signal, detection completed display is made on the display part 5 at Step S450, and this flow is finished.

In this variation, once the correlation table is created as above, the tag ID of the RFID circuit element To can be directly acquired using the correlation table only by reading out the barcode information.

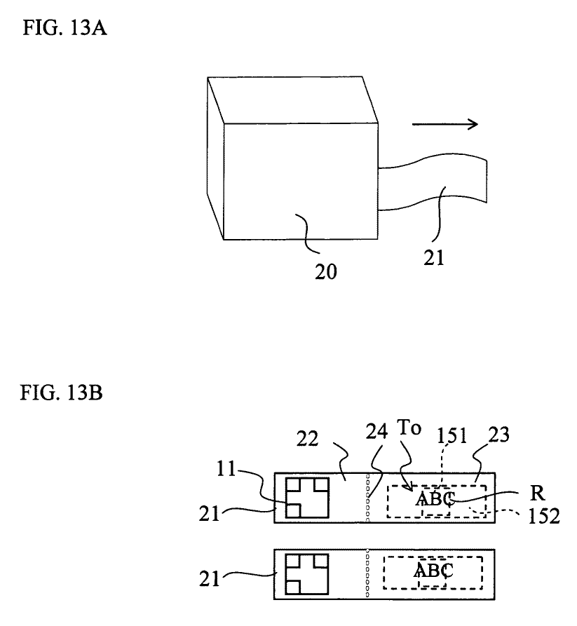

A third embodiment of the present invention will be described using FIGS. 13 to 15. This embodiment is an embodiment of an apparatus for producing a RFID tag with barcode as an apparatus for communicating with a RFID tag using optical information to which the present invention is applied.

FIG. 13A is a perspective view schematically illustrating an apparatus for producing a RFID label with barcode according to this embodiment, and FIG. 13B is a plan view illustrating a RFID label produced by this apparatus. That is, an apparatus 20 for producing a RFID label with barcode shown in FIG. 13A produces and discharges a RFID label 21 with barcode as shown in FIG. 13B.

As shown in FIG. 13B, the RFID label 21 is constituted by a barcode label region 22 in which the barcode 11 is provided and a RFID label region 23 in which the RFID circuit element To is provided, and between the barcode label region 22 and the RFID label region 23, a half-cut separation line 24 is provided so that these parts can be easily separated by hand.

The barcode 11 is a two-dimensional barcode in this example, and the barcode label region 22 is formed by printing, for example. Also, on the RFID label region 23 in which the RFID label is provided, a desired print R corresponding to the stored contents of the IC circuit part 140 of the RFID circuit element To is printed.

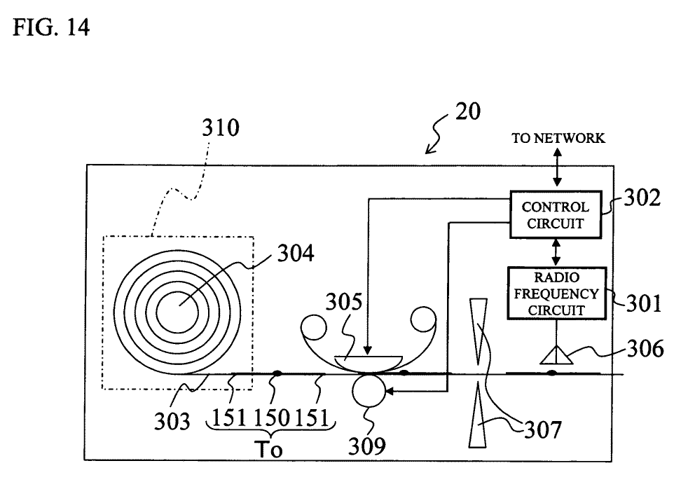

FIG. 14 is an explanatory diagram illustrating detailed configuration of the apparatus 20 for producing a RFID label with barcode shown in FIG. 13A.

In FIG. 14, the apparatus 20 for producing a RFID label with barcode includes a roll of a tape with RFID tags holder portion 310 to which a roll of a tape with RFID tags 304 with a tag tape 303 (tag medium) provided with the RFID circuit elements To with a predetermined interval wound around can be detachably attached (or a cartridge provided with the roll of a tape with RFID tags 304 can be detachably attached), a feeding roller 309 (feeding device) configured to feed the tag tape 303 fed out of the roll of a tape with RFID tags 304, a print head 305 (printing device, identifier forming device, related information processing device) configured to print the barcode 11 on a region corresponding to the barcode label region 22 in the tag tape 303 and to print the print R on the RFID circuit element To corresponding to the RFID label region 23, an antenna 306 (second communication device) configured to transmit/receive information by radio communication with the RFID circuit element To, a cutter 307 configured to cut the tag tape 303 on which print on the tag tape 303 and the information writing on the RFID circuit element To have been finished to a predetermined length (also may be functioned as separation line forming device configured to form the separation line 24), and a control circuit 302 configured to integrate and control these portions.

A radio frequency circuit 301 and the control circuit 302 are provided with the function substantially equivalent to the radio frequency circuit 201 and the control circuit 202 of the reader 1, though detailed description will be omitted, which creates access information to the IC circuit part 150 of the RFID circuit element To, transmits it to the RFID circuit element To through an apparatus antenna 306, and writes information in the IC circuit part 150 of the RFID circuit element To. The control circuit 302 is connected to the server 207, other computers, terminals and the like through the wired or radio communication line (network) 206 and capable of information transmission/reception.

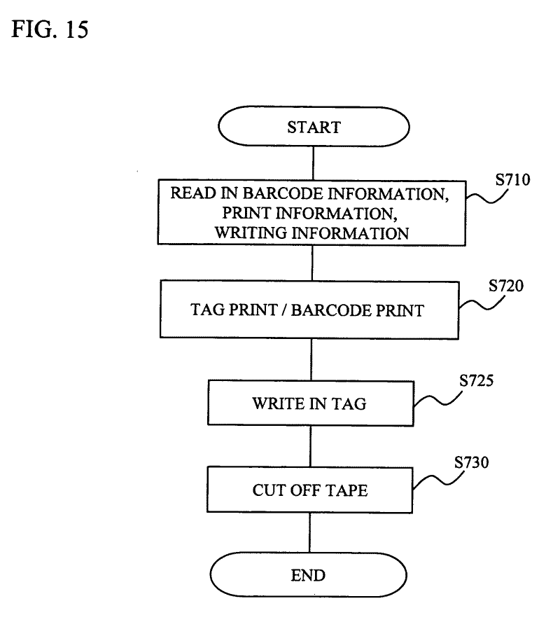

FIG. 15 is a flowchart illustrating a control procedure executed by the control circuit 302.

In FIG. 15, first, at Step S710, the barcode information to be printed by the print head 305 on the barcode label region 22 separately input by the operation terminal and the like connected to the control circuit 302 through the communication line, print information of the print R to be printed on the RFID label region 23, and writing information to the RFID circuit element To are got.

Subsequently, the routine goes to Step S720, where a control signal is output to the feeding roller 309 so as to start feeding of the tag tape 303 and a control signal is output to the print head 305 so that the print R and the barcode 11 are printed on regions corresponding to the RFID label region 23 and the barcode label region 22 of the tag tape 303, respectively. The contents of the print R and the barcode information of the barcode 11 printed at this time are made to correspond to the information to be written in at Step S725, which will be described later. Particularly the barcode 11 records the tag grasping information (article number information, article information and the like), mentioned in the first and second embodiments and their variations.

Then, at Step S725, the tag tape 303 is fed to a predetermined tag writing position and the information (RFID tag information including the tag ID) is written in.

Subsequently, the routine goes to Step S730, where a control signal is output to the feeding roller 309 when the tag tape 303 reaches a predetermined cutting position so as to stop the feeding, a control signal is output to a driving device (not shown) that drives the cutter 307 so as to drive the cutter 307 and tape cutting is performed. As a result, the RFID label 21 with barcode consisting of the barcode label region 22 provided with the barcode 11 and the RFID label region 23 provided with the RFID circuit element To is produced, and this flow is finished.

As mentioned above, in this embodiment, to the RFID circuit element To provided at the tag tape 303, information is transmitted/received (information writing) by the antenna 306 and the radio frequency circuit 301 through the radio communication. Also, at this time, the barcode 11 corresponding to the information transmission/reception contents is formed by the print head 305 on the barcode label region 22 in the tag tape 303, by which the RFID label 21 with barcode is produced.

After the label 21 has been produced as above, the barcode label region 22 and the RFID label region 23 can be easily cut off and separated by hand at the separation. line 24, and they can be affixed at separate locations for use. It may be so configured that the separation line 24 itself is made a full-cut line instead of the half-cut line so that a label of the barcode label region 22 and a label of the RFID label region 23 are produced in a separate state from the beginning.

At this time, since the barcode 11 records the tag grasping information that can grasp the RFID circuit element To as mentioned above, at the reading out by the reader 1 after that, using the tag grasping information detected and got using the barcode sensor 3 similarly to the first or second embodiment, the RFID circuit element To be communicated with can be grasped.

As a result, as mentioned in the first or second embodiment, even if there is a plurality of articles to be detected in the communication range from the antenna 2, the article detection based on the information transmission/reception result with the above-grasped RFID circuit element To can be completed (including inspection of checking only the number of articles as in the first embodiment).

In the above, in the RFID label 21 with barcode, the separation line 24 such as half cut is provided so that a portion of the barcode 11 and a portion of the RFID circuit element To can be easily separated by cutting-off by hand, but the separation may be realized by cutting with scissors or tearing-off with hand, and in those cases, the separation line 24 is not necessarily needed.

The “Scroll ALL ID” signal, the “Scroll ID” signal, the “Ping” signal and the like used in the above shall comply with the specification formulated by EPC global. The EPC global is a non-profit corporation jointly established by International EAN Association, which is an international organization of distribution codes, and UCC (Uniformed Code Council), which is an U.S. distribution code organization. Signals complying with other standards will do as long as they serve the same functions.

Other than those mentioned above, methods of the embodiments and each variation may be combined as appropriate for use.

Though not specifically exemplified, the present invention should be put into practice with various changes made in a range not departing from its gist.

What is claimed is:

1. An apparatus for communicating with a RFID tag using optical information, comprising:
a communication device configured to perform radio communication with a RFID circuit element provided with an IC circuit part storing information and an antenna for information transmission/reception; and
a related information processing device configured to optically get related information relating to information transmission/reception with said RFID circuit element through said communication device or to record the information in a target to be imparted, capable of being optically got.

2. The apparatus for communicating with a RFID tag using optical information according to claim 1, wherein:
said communication device is a first communication device configured to perform radio communication with said RFID circuit element provided at an article to be detected,
said related information processing device is an information acquisition device configured to optically get, from an optical identifier having tag grasping information for grasping said RFID circuit element to be communicated with said first communication device, said tag grasping information as said related information.

3. The apparatus for communicating with a RFID tag using optical information according to claim 2, wherein:
said information acquisition device gets plural tag related information relating to a plurality of said RFID circuit elements respectively provided at a plurality of said articles as said tag grasping information from said optical identifier comprehensively associated with said plurality of articles.

4. The apparatus for communicating with a RFID tag using optical information according to claim 3, wherein:
said information acquisition device gets number information of said plurality of articles as said plural tag related information.

5. The apparatus for communicating with a RFID tag using optical information according to claim 4, further comprising a first determining portion configured to check and determine the number information of said plurality of articles got by said information acquisition device and the number of said RFID circuit elements relating to said plurality of articles got through said first communication device.

6. The apparatus for communicating with a RFID tag using optical information according to claim 3, wherein:
said information acquisition device gets at least a part of identification information of said RFID circuit element as said plural tag related information.

7. The apparatus for communicating with a RFID tag using optical information according to claim 6, wherein:
said information acquisition device gets at least a part of identification information of a plurality of said RFID circuit elements provided at each of the plurality of articles as said plural tag related information.

8. The apparatus for communicating with a RFID tag using optical information according to claim 2, wherein:
said information acquisition device gets attribute information relating to said article as said tag grasping information from said optical identifier, said attribute information stored in said IC circuit part of said RFID circuit element provided at the article.

9. The apparatus for communicating with a RFID tag using optical information according to claim 8, further comprising:
a second determining portion configured to check and determine said attribute information got by said information acquisition device and said attribute information stored in said RFID circuit element and got through said first communication device; and
an identification information specifying portion configured to specify identification information of said RFID circuit element storing attribute information matching said attribute information got by said information acquisition device based on a determination result by said second determining portion.

10. The apparatus for communicating with a RFID tag using optical information according to claim 6, further comprising a correlation creating portion configured to create, after specifying said RFID circuit element to be communicated with using said tag grasping information, correlation between identification information of the specified RFID circuit element and said tag grasping information corresponding thereto.

11. The apparatus for communicating with a RFID tag using optical information according to claim 1, further comprising a feeding device configured to feed a tag medium having said RFID circuit element, wherein:
said communication device is a second communication device configured to perform information transmission/reception with said RFID circuit element of said tag medium fed by said feeding device through radio communication; and
said related information processing device is an identifier forming device configured to form an optical identifier corresponding to an information transmission/reception content with said RFID circuit element by said second communication device in said tag medium.

12. The apparatus for communicating with a RFID tag using optical information according to claim 11, wherein:
said identifier forming device is a printing device configured to print a barcode as said optical identifier on said tag medium in cooperation with feeding by said feeding device.

13. The apparatus for communicating with a RFID tag using optical information according to claim 12, wherein:
said printing device prints a two-dimensional barcode on said tag medium as said optical identifier.

14. The apparatus for communicating with a RFID tag using optical information according to claim 11, further comprising a separation line forming device configured to form a separation line capable of separating a portion on which said optical identifier is formed from a portion provided with said RFID circuit element can be separated, in said tag medium.
